(19) United States
(12) Patent Application Publication
(10) Pub. No.: US 2007/0124805 A1
(43) Pub. Date: May 31, 2007

(54) Cookie with multiple staged logic for identifying an unauthorized type of user

(75) Inventors: Min Zhou, Palo Alto, CA (US); Zhaowei C. Jiang, San Jose, CA (US); Michael J. Temkin, San Francisco, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/288,577

(22) Filed: Nov. 29, 2005

(51) Int. Cl. H04L 9/32

(52) U.S. Cl. 726/5

(57) ABSTRACT

One or more staged cookies are used to control access to a special service, such as a service to send clips of search results to a mobile device. In one embodiment, a client obtains a staged cookie when the client completes a permitted task that a server determines is performed by a typical user and not by a client programmed to circumvent server protections. One or more staged cookies indicate a trust level based on the client behavior with or without client registration, authentication, or other conventional security scheme. The server may digitally sign each issued cookie to ensure they are valid. When a client submits a request, the server checks the staged cookies to determine whether the client should be allowed to access the special service. The staged cookies enable a client user to remain anonymous, but also enable a server to prevent abuses, such as spam.

### FIELD OF ART

The present invention relates generally to controlling network access, and more particularly, but not exclusively, to using staged cookies to control access to a special service or data without requiring user identification.

### BACKGROUND

Many online services are readily available for public use. For example, internet search portals often provide free searching services that are accessible through a client browser program. Such services are generally used anonymously, without requiring a user to register for the service, or otherwise identify himself or herself. Other online services typically utilize some sort of registration to keep track of which data is associated with which user. For example, numerous free email services are available for use through browser programs. To access such services, a client user typically registers using some sort of user identifier (ID), so that the user may log into the service. User registration also enables service providers to determine which users may be abusing the service, such as by sending unsolicited messages (e.g., spam).

Information from an unregistered service, such as internet searching, is generally not transferable to a registered service, such as email, without first registering and logging into the registered service. For example, to communicate an internet search result to another user of an email system, a user typically logs into the email system and copies the search result (or resulting link) into an email message to the other user. This can be time consuming, especially if the user simply wishes to send the search result to himself or herself for later reference. It is desirable to send the search result, or other information from a non-registration service, directly to a messaging address (e.g., email address, mobile telephone number, etc.), without have to register and/or log into the messaging system. However, such anonymous access to a somewhat protected service such as a messaging service, may increase abuse of the protected service.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a computing device that may be included in a system implementing the invention;

FIG. 3 illustrates one embodiment of an architecture for implementing an embodiment of the present invention; and

FIG. 4 is a flow diagram illustrating exemplary logic for one embodiment of the invention.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense. Briefly stated, aspects of the present invention are directed towards controlling access to a special service or data by a user that is not specifically authorized for such access. Although the invention is not so limited, an exemplary embodiment is described below in terms of a server determining a trust level of a client based on staged cookies to control access by the client to a special service.

Illustrative Operating Environment

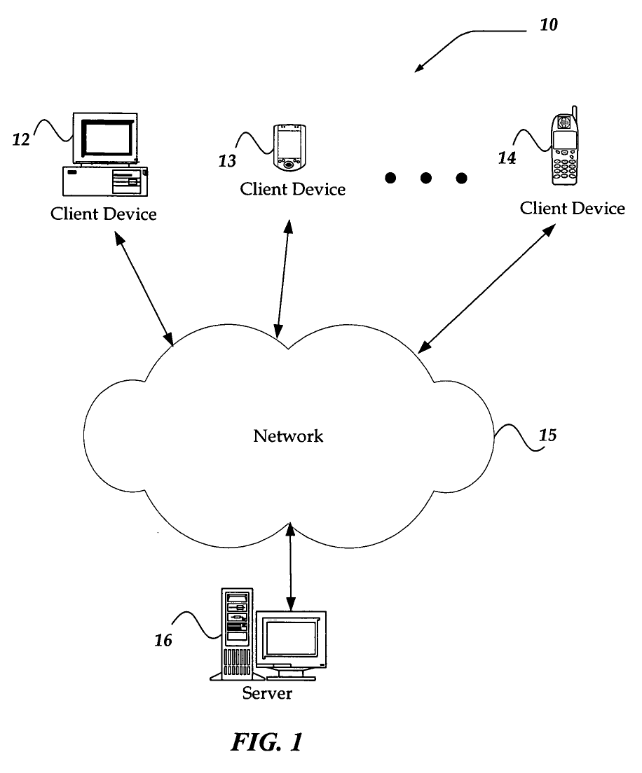

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, and a server 16. Network 15 is in communication with and enables communication between each of client devices 12-14, and server 16. The server generally controls access to services, and may include the services. Varying levels of services may be available, including general services and special services that require a sufficient trust level for access. General services may include a portal service, a search service, and/or other services that are generally open to public use without pre-authorization. Special services may include a particular messaging service, a premium service, or other service that is protected from access in some respect. Access to a special service need not require pre-authorization, but generally involves determining some level of trust.

Client devices 12-14 may include virtually any computing device capable of receiving and sending a message over a network, such as network 15, to and from another computing device, such as server 16, each other, and the like. The set of such devices may include devices that are usually considered general purpose devices and often connect using a wired communications medium such as personal computers, multiprocessor systems, microprocessor-based or programmable consumer electronics, network PCs, and the like. The set of such devices may also include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to control settings, and to instruct the client device to perform operations. Each client device also includes a communication interface that enables the client device to send and receive messages from another computing device employing the same or a different communication mode, including, but not limited to email, instant messaging (IM), short message service (SMS) messaging, multi-media message service (MMS) messaging, internet relay chat (IRC), Mardam-Bey's internet relay chat (mIRC), Jabber, and the like. Client devices 12-14 may be further configured with a browser application that is configured to receive and to send web pages, web-based messages, and the like. The browser application may be configured to receive and display graphics, text, multimedia, and the like, employing virtually any web based language, including, but not limited to Standard Generalized Markup Language (SGML), HyperText Markup Language (HTML), Extensible HyperText Markup Language (xHTML), Extensible Markup Language (XML), a wireless application protocol (WAP), a Handheld Device Markup Language (HDML), such as Wireless Markup Language (WML), WMLScript, JavaScript, and the like.

Network 15 is configured to couple one computing device to another computing device to enable them to communicate. Network 15 is enabled to employ any form of medium for communicating information from one electronic device to another. Also, network 15 may include a wireless interface, such as a cellular network interface, and/or a wired interface, such as an Internet interface, in addition to an interface to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links that are equivalent and/or known to those skilled in the art. Furthermore, remote computers and other related electronic devices could be remotely connected to either LANs or WANs via a modem and temporary telephone link. In essence, network 15 includes any communication method by which information may travel between client devices 12-14, and/or server 16. Network 15 is constructed for use with various communication protocols including transmission control protocol/internet protocol (TCP/IP), WAP, code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as acoustic, RF, infrared, and other wireless media, and wired media such as twisted pair, coaxial cable, fiber optics, wave guides, and other wired media.

Exemplary Computing Environment

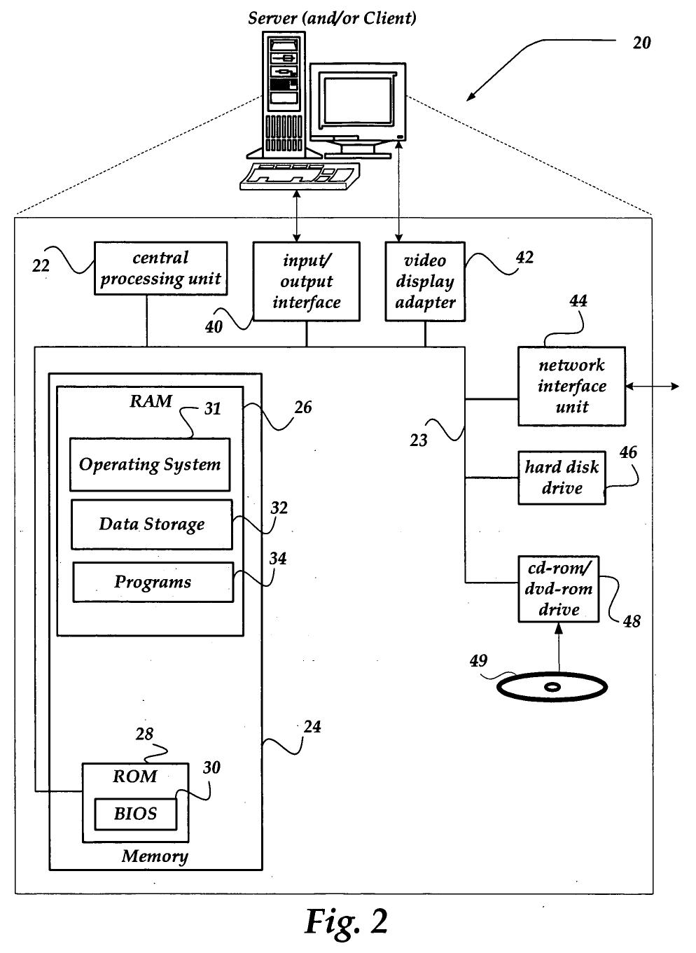

FIG. 2 shows one embodiment of a server device 20 that may be included in a system implementing the invention. Server device 20 may include many more or less components than those shown. However, the components shown are sufficient to disclose an illustrative embodiment for practicing the present invention. In this sample embodiment, server device 20 is generally configured as general purpose computer. However, a dedicated device, a client device, a mobile device, or other device may be used. Briefly, server device 20 may include any computing device capable of connecting to network 15 to enable a user to communicate with other devices. Server device 20 may or may not be combined with, in communication with, or otherwise associated with portal services, such as messaging services, news services, financial services, search services, and the like. Many of the components of server device 20 may also be duplicated in a server of a portal service, a server of a separate messaging service, and/or other server devices.

As shown in the figure, server device 20 includes a processing unit 22 in communication with a mass memory 24 via a bus 23. Mass memory 24 generally includes a RAM 26, a ROM 28, and other storage means. Mass memory 24 also illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 24 stores a basic input/output system (“BIOS”) 30 for controlling low-level operation of server device 20. The mass memory also stores an operating system 31 for controlling the operation of server device 20. It will be appreciated that this component may include a general purpose operating system such as a version of Windows™, UNIX, LINUX™, or the like. The operating system may also include, or interface with a virtual machine module that enables control of hardware components and/or operating system operations via application programs.

Mass memory 24 further includes one or more data storage units 32, which can be utilized by server device 20 to store, among other things, data for programs 34 and/or other data. Programs 34 may include computer executable instructions which can be executed by server device 20 to implement application programs including schedulers, calendars, web services, transcoders, database programs, word processing programs, spreadsheet programs, and so forth. Accordingly, programs 34 can process data communications, web pages, audio, video, and enable telecommunication with other electronic devices.

In addition, mass memory 24 may store one or more programs for authorizing user access, messaging, gaming and/or other applications. Some applications, services, and/or data may be considered special, requiring some level of trust for a client to access such applications, services, and/or data. An example may be a messaging module that may include computer executable instructions, which may be run under control of operating system 31 to enable email, SMS, MMS, instant messaging, and/or other messaging services. Similarly, server device 20 may provide routing, access control, and/or other server-side messaging services. Server device 20 may further include a portal server, which provides portal services, including shopping services, social networking services, mapping services, and the like. A server device configured much like server device 20 (and/or server device 20 itself) may include a monitoring module (not shown) that monitors activity of online services.

Server device 20 also includes an input/output interface 40 for communicating with input/output devices such as a keyboard, mouse, wheel, joy stick, rocker switches, keypad, printer, scanner, and/or other input devices not specifically shown in FIG. 2. A user of server device 20 can use input/output devices to interact with a user interface that may be separate or integrated with operating system 31 and/or programs 34-38. Interaction with the user interface includes visual interaction via a display, and a video display adapter 42.

Server device 20 may include a removable media drive 44 and/or a permanent media drive 46 for computer-readable storage media. Removable media drive 44 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 49, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 244, server device 20 can communicate with a wide area network such as the Internet, a local area network, a wired telephone network, a cellular telephone network, and/or some other communications network, such as network 15 in FIG. 1. Network communication interface unit 44 is sometimes known as a transceiver, transceiving device, network interface card (NIC), and the like.

Exemplary Architecture

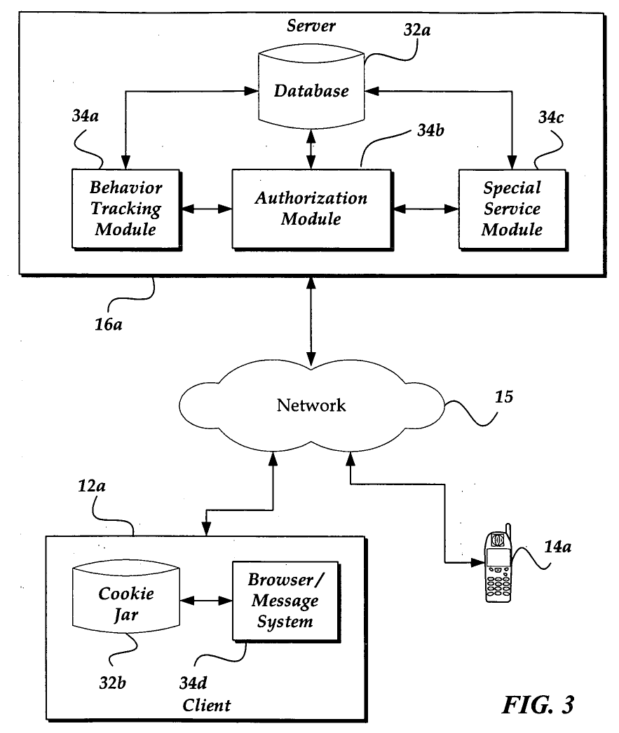

FIG. 3 illustrates one embodiment of an architecture for practicing the present invention. However, not all of the illustrated modules may be required to practice the invention, and variations in the arrangement and type of the components may be made without departing from the spirit or scope of the invention.

As shown in the figure, a server 16a includes a data storage unit and a number of program modules. A database 32a generally stores various data, which may include data regarding users who may be registered or not registered with the server for access to various services. If a user has already been determined to be trustworthy (whitelisted), user data may be stored in database 32a for quicker access. Conversely, if a user has already been determined to be untrustworthy (blacklisted), user data may be stored in database 32a to prevent the user from accessing some or all services. Data for or about anonymous or unregistered users need not be stored in database 32a, since such information may be stored in cookies stored on clients, such as a client 12a. Similarly, an anonymous or unregistered user may be identified by an identifier placed in a cookie that is stored on a corresponding client. Other means of identifying an unregistered user may include using an address of the unregistered user (e.g., IP address, unregistered email address, mobile station ISDN number (MSISDN), etc.), using a port number, and/or other temporary or permanent identifier. An authorization module 34b is in communication with user database 32a, and generally controls access to the server and/or services available through the server. A behavior tracking module 34a is in communication with authorization module 34b and with user database 32a, and generally monitors requests, responses, actions, and/or other behaviors of users that access server 16a. For example, behavior tracking module 34a may track which services a user requests, a frequency with which a user accesses the server, the address(es) from which a user accesses the server, and/or other actions of users. A special service module 34c may include any service to which access is controlled. For example, a messaging service, such as an SMS service, may be accessible only to those users (registered or unregistered) who have satisfied one or more trust requirements. User behaviors may be used to determine varying levels of trust for access to various special services.

Server 16a is accessible via network 15 by one or more clients, such as general client 12a and mobile client 14a. In this exemplary embodiment, general client 12a is generally configured for general purpose computing and mobile client 14 is generally configured for limited computing such as that found in cellular telephones, PDAs, and the like. General client 12a includes a data store 32a, which stores one or more cookies from other network nodes, such as server 16a. The one or more cookies may be associated with a particular network node and/or with nodes of a related network service such that related cookies are referred to as cookie jar. Client 12a also generally includes a communication system 34d, which may comprise a browser, a message system, and/or other communication services.

The communication system may interact with server 16a and/or other clients. One interaction may include requesting a special service from server 16a. For example, general client 12a may clip a portion of an internet search result and request server 16a to communicate the clipped portion to mobile client 14a. Before providing this special service, general client 12a may first have to build sufficient trust with server 16a through interactions with server 16a that cause one or more cookies to be stored in cookie jar 32b. If the cookies indicate that general client 12a is trustworthy (even if client 12 is not registered), server 16a may provide the special service of communicating the clipped portion to mobile client 14a, and/or other special services.

Exemplary Logic

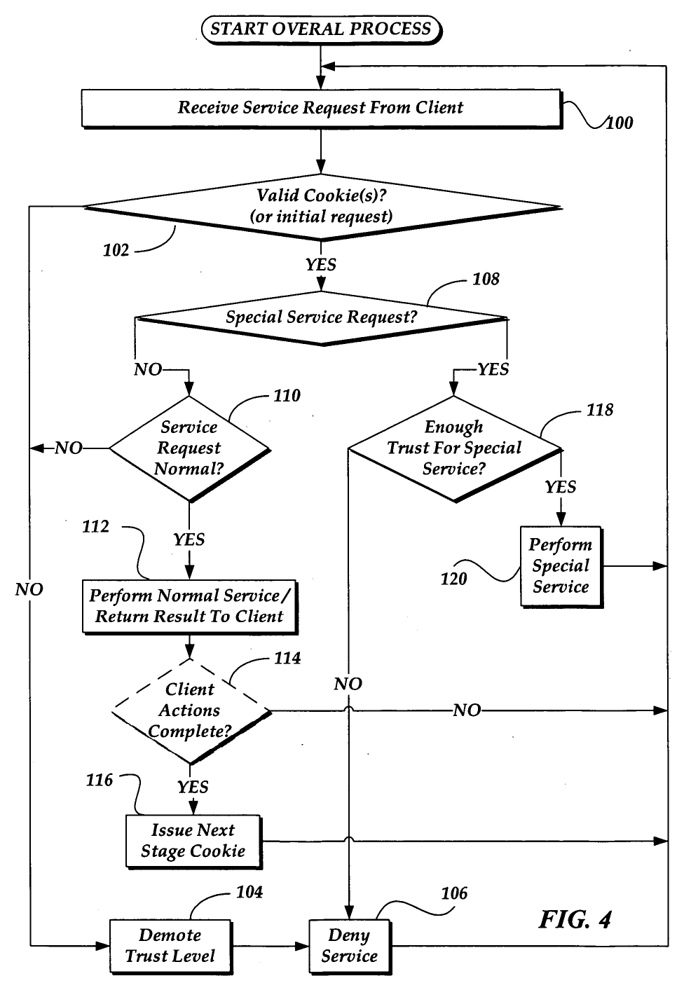

FIG. 4 illustrates one embodiment of exemplary logic for controlling access to a special service. However, not all of the illustrated operation may be required to practice the invention, and variations in the arrangement and type of the operation may be made without departing from the spirit or scope of the invention. At an operation 100, an authorization module of the server receives a request from a client. This may be the first request from this particular client or a subsequent request. A user of the client may be registered to use the server through a portal service or other network service. However, in many cases, the user is not registered, and remains anonymous. Nevertheless, the server may identify the client with an identifier stored in a cookie.

At a decision operation 102, the authorization module checks for a valid cookie, or set of cookies. If this is an initial request, such that no cookie currently exists or a prior cookie is expired, a new cookie may be placed on the client. The cookie is generally secured in some manner, such as being digitally signed with an encrypted time stamp. If a new cookie was just placed, a second check need not be made. Alternatively, if a cookie, or set of cookies already exist on the client, the authorization module ensures that the cookies are signed, not expired, or otherwise valid. The authorization module may check for one or more particular cookies that may be needed to access a special service. If one or more of the cookies are not valid, or a required cookie is not present, the authorization module may demote a trust level for the client, at an operation 104. The authorization module may also deny the client's service request, at an operation 106.

If the cookies are valid, the authorization module determines, at a decision operation 108, whether the service request was for a special service. If the client did not request a special service, the authorization module may further determine whether the service request was normal, at a decision operation 110. A normal service request may be defined in any number of ways. In general, a normal service request may comprise a request for a non-special service permitted by the authorization module and typically made by a trustworthy user. For example, the authorization module may determine from time stamps whether the service request was made after a sufficient period since a prior service request. A very short time period, such as less than 5 seconds, may suggest that the client is not controlled by a human user, but is controlled by a program designed to send spam. Similarly, the authorization module may determine whether the service request involves distributing information to large numbers of other clients. The authorization module may compare the current service request with prior service requests from this client and/or other clients to determine which service requests are typical for trustworthy clients. Alternatively, predefined service requests may be considered trustworthy, while other service requests are not. A number of analyses and/or determinations may be employed to determine whether the current service request is normal. If a current service request is not considered normal, or otherwise permitted, the authorization module may demote the client's trust level and/or deny the service request.

If the current service request is considered normal, the authorization module allows the server to begin performing the requested service and/or prepare a result, at an operation 112. At a optional decision operation 114, the authorization module may determine whether the client completed some necessary action associated with the current request, the service, and/or the result. For example, if the client requested an internet search, the authorization module may expect a subsequent selection of one of the resulting links to indicate that a true user is operating the client, and the client is not simply programmed to perform tasks intended to circumvent the authorization module. If the authorization module does not receive an indication that the necessary action was completed, no further action may be taken, and control may return to operation 100 to await another service request. In alternate embodiment, and/or for certain actions, a user's failure to perform a certain action may cause the client's trust level to be demoted and/or further service may be denied.

If the necessary action was completed, or the optional verification is not included, the authorization module issues a next cookie to the client, at an operation 116. The next cookie is sometimes referred to herein as a staged cookie. A staged cookie may be associated with the service request, may be associated with a level of trust, or may otherwise indicate some valid interaction with the server. One or more staged cookies may be stored in a cookie jar on the client, which is checked by the authorization module during subsequent service requests.

If the authorization-module determines at decision operation 112 that the service request is for a special service, a determination is made at decision operation 118 whether the client is trusted enough to warrant providing the special service to the client. One or more trust criteria may be based on a number of staged cookies accumulated in the client's cookie jar. Alternatively, or in addition, the trust criteria may be determined based on a point system. For example, a staged cookie may be assigned a particular point value based on the type of corresponding service request, based on other user actions associated with the corresponding service request, and/or based on other criteria. A trust criterion may comprise a trust threshold, which may be established simply on a number of points, on a predefined sequence of staged cookies, or other system. If the trust criteria are met, the special service is performed at an operation 120.

The above specification, examples, and data provide a complete description of the manufacture and use of the composition of the invention. However other embodiments will be clear to one skilled in the art. For example, one or more of the authorization checks could be performed by the client and/or other intermediaries prior to requesting the special service. Since many embodiments of the invention can be made without departing from the spirit and scope of the invention, the invention resides in the claims hereinafter appended.

What is claimed as new and desired to be protected by Letters Patent of the United States is:

1. A method for controlling access to a special service, comprising:
determining whether a trust criterion is met based at least in part on a staged cookie associated with a client, wherein the staged cookie comprises a trust indicator indicating a prior permitted action of the client; and
enabling access to the special service if the trust criterion is met.

2. The method of claim 1, wherein the prior permitted action is not associated with distribution of an unsolicited message.

3. The method of claim 1, wherein the trust criterion comprises accumulation of a plurality of staged cookies, each associated with a prior permitted action of the client.

4. The method of claim 1, further comprising: making a determination that a task was completed by a user of the client in relation to a prior non-special service request; and issuing the staged cookie to the client.

5. The method of claim 1, further comprising determining that the staged cookie is valid prior to enabling access to the special service.

6. The method of claim 1, wherein the special service comprises communicating a clipped portion of a prior result to a mobile device.

7. A server device for controlling access to a special service, comprising:
a communication interface in communication with a client;
a memory for storing instructions and data; and
a processor in communication with the communication interface and with the memory, wherein the processor performs actions based at least in part on the stored instructions, including:
determining whether a trust criterion is met based at least in part on a staged cookie associated with a client, wherein the staged cookie comprises a trust indicator indicating a prior permitted action of the client; and
enabling access to the special service if the trust criterion is met.

8. The server device of claim 7, wherein the prior permitted action is not associated with distribution of an unsolicited message.

9. The server device of claim 7, wherein the trust criterion comprises accumulation of a plurality of staged cookies, each associated with a prior permitted action of the client.

10. The server device of claim 7, wherein the processor further performs the actions of:
making a determination that a task was completed by a user of the client in relation to a prior non-special service request; and
issuing the staged cookie to the client.

11. The server device of claim 7, wherein the processor further performs the action of determining that the staged cookie is valid prior to enabling access to the special service.

12. The server device of claim 7, wherein the special service comprises communicating a clipped portion of a prior result to a mobile device.

13. A method for accessing a special service, comprising:
storing a staged cookie that comprises a trust indicator indicating a prior permitted action;
providing the indicator of the staged cookie to an authorization module for determining whether a trust criterion is met; and
accessing the special service if the trust criterion is met.

14. The method of claim 13, wherein the prior permitted action is not associated with distribution of an unsolicited message.

15. The method of claim 13, further comprising accumulating a plurality of staged cookies to satisfy the trust criterion, each associated with a prior permitted action.

16. The method of claim 13, further comprising, prior to storing the staged cookie, performing a task based on input from a user, wherein the task is associated with a prior non-special service request.

17. A client device for accessing a special service, comprising:
a communication interface in communication with the special service;
a memory for storing instructions and data; and
a processor in communication with the communication interface and with the memory, wherein the processor performs actions based at least in part on the stored instructions, including:
storing a staged cookie that comprises a trust indicator indicating a prior permitted action;
providing the indicator of the staged cookie to an authorization module for determining whether a trust criterion is met; and
accessing the special service if the trust criterion is met.

18. The client device of claim 17, wherein the prior permitted action is not associated with distribution of an unsolicited message.

19. The client device of claim 17, wherein the processor further performs the action of, prior to storing the staged cookie, performing a task based on input from a user, wherein the task is associated with a prior non-special service request.

20. The client device of claim 17, wherein the client device comprises a mobile device.
